(19) United States
(12) Patent Application Publication
(10) Pub. No.: US 2012/0187787 A1
(43) Pub. Date: Jul. 26, 2012

(54) MOTOR AND ROTARY DRIVE DEVICE

(75) Inventor: Yutaka SAITO, Nagano (JP)

(73) Assignee: NIDEC SANKYO CORPORATION, Nagano (JP)

(21) Appl. No.: 13/352,674

(22) Filed: Jan. 18, 2012

(30) Foreign Application Priority Data
Jan. 21, 2011 (JP) 2011-011212

(51) Int. Cl. H02K 21/24; H02K 7/116

(52) U.S. Cl. 310/83; 310/156.34

(57) ABSTRACT

A motor may include a motor housing; a rotor which is provided with a rotation shaft rotatably held with respect to the motor housing, a magnet held by the rotation shaft, and a back yoke facing the magnet on one side in a motor axial line direction; a stator board which is provided with a stator coil facing the magnet on an other side in the motor axial line direction; an auxiliary yoke mounting member which is provided with a tube part to which the rotation shaft fitted and fixed; and an auxiliary yoke which is provided in a portion of the auxiliary yoke mounting member whose diameter is enlarged from the tube part and which faces the stator board on the other side in the motor axial line direction.

### CROSS REFERENCE TO RELATED APPLICATION

The present invention claims priority under 35 U.S.C. §119 to Japanese Application No. 2011-011212 filed Jan. 21, 2011, the entire content of which is incorporated herein by reference.

### FIELD OF THE INVENTION

At least an embodiment of the present invention may relate to a motor in which a rotor magnet and a stator coil are faced each other in a motor axial line direction and may relate to a rotary drive device provided with the motor.

### BACKGROUND

A surface facing type motor in which a magnet of a rotor and a stator coil are faced in a motor axial line direction is, as shown in FIG. 7(a), provided with a rotor 4 having a rotation shaft 5 rotatably held by a motor housing 2, and a stator board 3 having a stator coil 3a facing the magnet 8 of the rotor 4 in a motor axial line “Lm” direction. The rotor 4 is provided with a back yoke 6 on a back side of the magnet 8 and an auxiliary yoke 7s fixed to a motor housing 2 or the like is faced at a position on an opposite side to the magnet 8 with respect to the stator board 3. Further, the auxiliary yoke 7s is superposed on the stator board 3 for supporting the stator board 3.

However, in the motor shown in FIG. 7(a), a large thrust force caused by the magnet 8 which is attracted to the auxiliary yoke 7s is applied to the thrust bearing 5c. Therefore, a frictional force between the thrust bearing 5c and the rotation shaft 5 is large and a large torque loss caused by the frictional force is occurred. Further, when the rotor 4 is rotated, an eddy current is generated in the auxiliary yoke 7s and the eddy current acts on the rotor 4 as a brake and thus a torque loss is occurred.

On the other hand, as shown in FIG. 7(b), a motor has been proposed in which an auxiliary yoke 19s is structured by using a part of a rotor 4 and the auxiliary yoke 19s is integrally rotated with the rotor 4 (see, Japanese Patent Laid-Open No. Hei 9-205762).

In the Patent Literature, a rotor frame 19 is provided with a plate-shaped disk part 19a having a hole into which a rotation shaft 5 is press-fitted, a tube part 19b having a thin wall thickness which is extended from an outer peripheral edge of the disk part 19a toward a motor axial line “Lm” direction so as to surround the rotation shaft 5, and a disk-shaped large diameter part 19c which is enlarged from an end part of the tube part 19b. The large diameter part 19c is utilized as an auxiliary yoke 7s. In a case that the auxiliary yoke 7s is rotated together with the rotor 4, the stator coil 3a is unable to be supported by the auxiliary yoke 7s and thus, in the motor described in the Patent Literature, an outer peripheral side end part of the stator coil 3a is fixed to an end part 2t of a bracket 2s.

In a case that the auxiliary yoke 19s is integrally rotated with the rotor 4 like the structure as described in the Patent Literature, the auxiliary yoke 19s is rotated in the vicinity of the stator coil 3a. However, in the rotor frame 19 provided with the plate-shaped disk part 19a, the tube part 19b having a thin wall thickness and the plate-shaped large diameter part 19c (auxiliary yoke 19s), since dimensional errors of the respective parts are accumulated in the auxiliary yoke 19s, dimensional accuracy of a gap space between the auxiliary yoke 19s and the stator coil 3a is low. Therefore, in a state that a magnetic attraction force is acted between the magnet 8 and the auxiliary yoke 19s, when the rotor frame 19 is slightly deformed during rotation of the rotor 4 at a high speed, the large diameter part 19c (auxiliary yoke 19s) and the stator coil 3a may be contacted with each other.

Further, like the structure as described in the Patent Literature, in a structure that the stator coil 3a is not supported by the auxiliary yoke 19s and the outer peripheral side end part of the stator coil 3a is superposed on and fixed to the end part 2t of the bracket 2s, positional accuracy in the motor axial line “Lm” direction of the stator coil 3a is low and thus the stator coil 3a may be contacted with the auxiliary yoke 19s.

### SUMMARY

In view of the problems described above, at least an embodiment of the present invention may advantageously provide a motor which is structured so that a magnet on a rotor side and a stator board provided with a stator coil are faced each other in a motor axial line direction and, even when an auxiliary yoke facing the stator board on an opposite side to a side where the magnet is located is provided on the rotor side, the stator board is not contacted with the auxiliary yoke. Further, at least an embodiment of the present invention may advantageously provide a rotary drive device provided with the motor.

According to at least an embodiment of the present invention, there may be provided a motor including a motor housing, a rotor which is provided with a rotation shaft rotatably held with respect to the motor housing, a magnet held by the rotation shaft, and a back yoke facing the magnet on one side in a motor axial line direction, a stator board which is provided with a stator coil facing the magnet on the other side in the motor axial line direction, an auxiliary yoke mounting member which is provided with a tube part to which the rotation shaft is fitted and fixed, and an auxiliary yoke which is provided in a portion of the auxiliary yoke mounting member whose diameter is enlarged from the tube part and which faces the stator board on the other side in the motor axial line direction.

In accordance with an embodiment of the present invention, an auxiliary yoke is attached to the rotor and the auxiliary yoke is integrally rotated with the rotor. Therefore, a magnetic attraction force acted between the magnet and the auxiliary yoke does not act on the rotation shaft as a thrust force. Further, since the magnet and the auxiliary yoke are integrally rotated with each other, an eddy current is not generated in the auxiliary yoke and thus a braking force due to the eddy current is not applied to the rotor. Therefore, occurrence of friction between a thrust bearing and the rotation shaft can be reduced and a torque loss due to the eddy current is avoided. Further, a structure having no thrust bearing may be adopted. Further, the auxiliary yoke is formed in a simple structure in which the auxiliary yoke is provided in a portion whose diameter is enlarged from the tube part and which faces the stator board on the opposite side in the motor axial line direction and thus a high degree of positional accuracy of the auxiliary yoke is attained. Therefore, in a case that the rotor is rotated at a high speed in a state that a magnetic attraction force is acted between the magnet and the auxiliary yoke, even when the auxiliary yoke is deformed to some extent, the auxiliary yoke is prevented from contacting with the stator board.

In accordance with an embodiment of the present invention, the auxiliary yoke mounting member is a magnetic member which is provided with a large diameter portion whose diameter is enlarged from the tube part and which faces the stator board on the other side in the motor axial line direction, and the auxiliary yoke is structured of the large diameter portion. According to this structure, since the auxiliary yoke is structured by utilizing a part of the auxiliary yoke mounting member, the number of part items is reduced.

In accordance with an embodiment of the present invention, the auxiliary yoke mounting member is provided with a large diameter portion whose diameter is enlarged from the tube part and which faces the stator board on the other side in the motor axial line direction, and the auxiliary yoke is fixed to the large diameter portion.

In accordance with an embodiment of the present invention, the motor housing comprises a plurality of housing members and an outer peripheral side end part of the stator board is sandwiched and held by the housing members adjacent to each other in the motor axial line direction. According to this structure, a high degree of positional accuracy in the motor axial line direction of the stator board is attained and thus the stator board and the auxiliary yoke are prevented from contacting with each other.

In accordance with an embodiment of the present invention, the stator board is provided with the stator coil which is formed with a copper foil pattern laminated on a substrate in a sheet-like shape or a thin plate shape. In this case, since the stator board is thin, positional accuracy of a portion of the stator board which faces the auxiliary yoke in the motor axial line direction may be easily lowered. However, in accordance with the embodiment of the present invention, the positional accuracy of the auxiliary yoke is high and thus the stator board is prevented from contacting with the auxiliary yoke.

In accordance with an embodiment of the present invention, the motor housing covers the rotor over an entire periphery or a substantially entire periphery in a circumferential direction of the rotor. According to this structure, the structure can be adopted in which the outer peripheral side end part of the stator board is sandwiched and held by the housing member over a wide range in the circumferential direction and thus the stator board is held surely. Further, when the entire periphery or the substantially entire periphery in the circumferential direction of the rotor is covered by the motor housing, foreign matters such as dust are prevented from entering into the inside of the motor housing.

In a case that the motor in accordance with the embodiment of the present invention is applied to a rotary drive device including a first driven member, a second driven member, a first actuator which is a rotation drive source for the first driven member, and a second actuator which is a rotation drive source for the second driven member, it is preferable that at least one of the first actuator and the second actuator is the motor in accordance with the embodiment of the present invention. In this case, it may be structured that the rotary drive device is provided with a first motor and a second motor, which are the above-mentioned motor, and a wave motion gear mechanism for transmitting rotations of the first motor and the second motor to the first driven member and the second driven member. The wave motion gear mechanism includes a circular spline in a tube-like shape having internal teeth, a flex spline provided with outer teeth whose teeth number is smaller than the teeth number of the internal teeth, and a wave generator which makes the flex spline resiliently bend to partially mesh the outer teeth with the internal teeth and to occur a relative turning between the circular spline and the flex spline by moving a meshing position of the outer teeth with the internal teeth in a circumferential direction.

In accordance with an embodiment of the present invention, the first driven member is a first shutter plate which is provided with a first light transmitting part and a first light shielding part in a circumferential direction, the second driven member is a second shutter plate which is provided with a second light transmitting part and a second light shielding part in a circumferential direction, and the first light transmitting part and the second light transmitting part are formed at positions so as to superpose on each other in a rotation center axial line direction. In this case, a rotary shutter device provided with two shutter plates is structured.

In accordance with an embodiment of the present invention, a magnetic member provided with an auxiliary yoke is provided in the rotor and the auxiliary yoke is integrally rotated with the rotor. Therefore, a magnetic attraction force acted between the magnet and the auxiliary yoke does not act on the rotation shaft as a thrust force. Therefore, a large torque loss caused by friction between the thrust bearing and the rotation shaft is not occurred and thus a structure having no thrust bearing may be adopted. Further, since the magnet and the auxiliary yoke are integrally rotated with each other, an eddy current is not generated in the auxiliary yoke and thus a braking force due to the eddy current is not applied to the rotor. Further, the auxiliary yoke is provided in a portion whose diameter is enlarged from the tube part into which the rotation shaft is fitted, in the magnetic member attached to the rotor. Therefore, even when the rotor is rotated in a state that a magnetic attraction force is acted between the magnet and the auxiliary yoke, the auxiliary yoke is prevented from being deformed and being contacted with the stator coil. Further, the stator board is surely sandwiched and held by the housing member and thus, even when vibration at the time of rotation of the rotor is applied, the stator board is prevented from being displaced and is prevented from contacting with the auxiliary yoke.

Other features and advantages of the invention will be apparent from the following detailed description, taken in conjunction with the accompanying drawings that illustrate, by way of example, various features of embodiments of the invention.

### BRIEF DESCRIPTION OF THE DRAWINGS

Embodiments will now be described, by way of example only, with reference to the accompanying drawings which are meant to be exemplary, not limiting, and wherein like elements are numbered alike in several Figures, in which:

FIGS. 1(a) and 1(b) are explanatory views showing a motor in accordance with a first embodiment of the present invention.

FIG. 2 is an explanatory view schematically showing a cross sectional structure of a motor in accordance with a second embodiment of the present invention.

FIGS. 3(a) and 3(b) are explanatory views showing an outward appearance of a rotary shutter device and the like to which at least an embodiment of the present invention is applied.

FIG. 4 is a longitudinal sectional view showing the rotary shutter device in FIGS. 3(a) and 3(b).

FIGS. 5(a) through 5(d) are explanatory views showing operations of the rotary shutter device in FIGS. 3(a) and 3(b).

FIG. 6 is a longitudinal sectional view showing another rotary shutter device to which at least an embodiment of the present invention is applied.

FIGS. 7(a) and 7(b) are explanatory views showing a conventional motor.

### DETAILED DESCRIPTION OF THE PREFERRED EMBODIMENTS

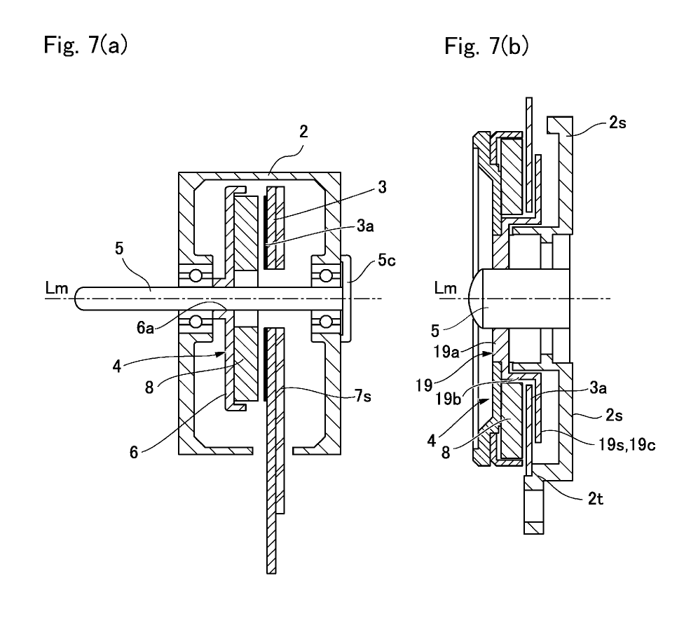

Embodiments of the present invention will be described below with reference to the accompanying drawings. In the following descriptions, a side where a rotation shaft is protruded in a motor axial line “Lm” direction is referred to as an output side “La” and an opposite side to the side where the rotation shaft is protruded is referred to as an opposite-to-output side “Lb”. Therefore, in a case that one side in the motor axial line “Lm” direction is set to be an output side “La”, the other side is an opposite-to-output side “Lb” and, in a case that one side in the motor axial line “Lm” direction is set to be an opposite-to-output side “Lb”, the other side is an output side “La”. Further, in the following descriptions, the same reference signs are used in portions corresponding to the structure described in FIGS. 7(a) and 7(b) for easy understanding.

### First Embodiment

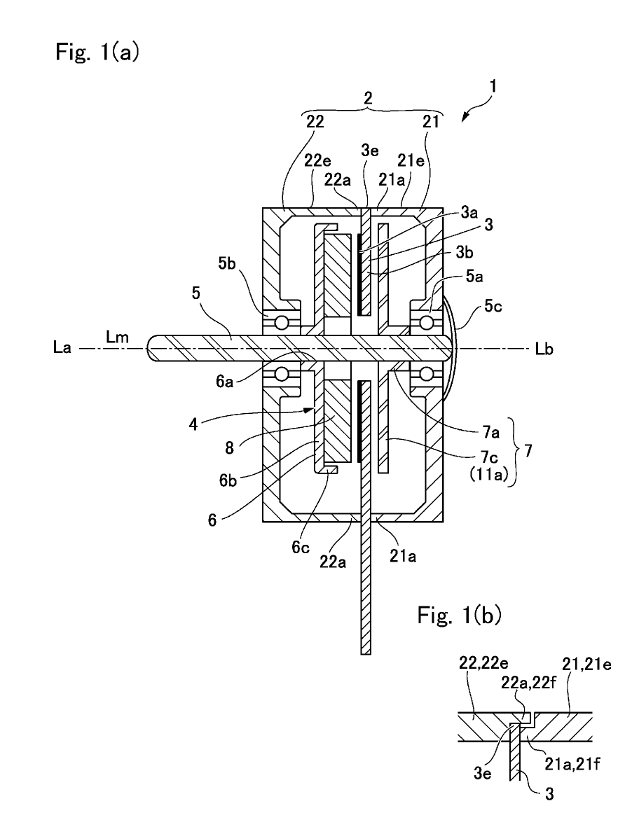

FIGS. 1(a) and 1(b) are explanatory views showing a motor in accordance with a first embodiment of the present invention. FIG. 1(a) is an explanatory view schematically showing a cross sectional structure of a motor and FIG. 1(b) is an explanatory view showing one example of a structure in which an outer peripheral side end part of a stator board is held by a housing member.

A motor 1 shown in FIG. 1(a) is a surface facing type motor in which a magnet 8 of a rotor 4 and a stator coil 3a are faced each other in a motor axial line “Lm” direction. The motor 1 includes a motor housing 2, a rotor 4 provided with a rotation shaft 5 which is rotatably held with respect to the motor housing 2 by radial bearings 5a and 5b and a thrust bearing 5c, and a stator board 3 provided with a stator coil 3a which faces the magnet 8 of the rotor 4 on an opposite-to-output side “Lb” in the motor axial line “Lm” direction. The rotor 4 is provided with a back yoke 6 on an output side “La” in the motor axial line “Lm” direction with respect to the magnet 8. The back yoke 6 is provided with a cylindrical tube part 6a to which the rotation shaft 5 is fitted, a circular plate part 6b whose diameter is enlarged from an end part on the opposite-to-output side “Lb” of the cylindrical tube part 6a, and a cylindrical tube shaped body part 6c which is formed to be bent from an outer peripheral side end part of the circular plate part 6b toward the opposite-to-output side “Lb”. A ring-shaped magnet 8 is fixed to a face on the opposite-to-output side “Lb” of the circular plate part 6b with an adhesive or the like.

The motor 1 is provided with the back yoke 6 on the back side of the magnet 8 and an auxiliary yoke 11a in a ring shape on an opposite side (opposite-to-output side “Lb”) to the side where the magnet 8 is located with respect to the stator coil 3a for efficiently forming a magnetic field interlinkaging with the stator coil 3a. In this embodiment, the auxiliary yoke 11a is attached to the rotor 4. In order to realize this structure, an auxiliary yoke mounting member 7 having a tube part 7a into which the rotation shaft 5 is fitted is provided, and the auxiliary yoke 11a is formed in a portion of the auxiliary yoke mounting member 7 whose diameter is enlarged from the tube part 7a and which faces the stator board 3 on the opposite-to-output side “Lb”.

More specifically, the auxiliary yoke mounting member 7 is a magnetic member provided with the tube part 7a, to which the rotation shaft 5 is fitted and fixed so as to be integrally rotated with each other, and a large diameter part 7c in a ring shape whose diameter is enlarged from an end part on the output side “La” of the tube part 7a. In the auxiliary yoke mounting member 7, the large diameter part 7c functions as the auxiliary yoke 11a which is located on the opposite side (opposite-to-output side “Lb”) to the side where the magnet 8 is located with respect to the stator coil 3a. Further, the tube part 7a is a mounting support part for the large diameter part 7c which functions as the auxiliary yoke 11a. Therefore, when a dimension in the axial direction of the tube part 7a is secured, positional accuracy is enhanced so that the large diameter part 7c is disposed in a direction perpendicular to the motor axial line “Lm” direction. Further, the auxiliary yoke mounting member 7 is fixed to the rotation shaft 5 so as to be integrally rotated with the rotation shaft 5 on the opposite side (opposite-to-output side “Lb”) to the side where the magnet 8 is located with respect to the stator coil 3a. Therefore, the inner peripheral side of the magnet 8 can be disposed near the rotation shaft 5 and thus an outer diameter of the motor 1 can be made small.

The motor housing 2 is structured of a plurality of housing members. In this embodiment, the motor housing 2 is structured of a first housing member 21 in a cup-like shape, which holds the radial bearing 5a and the thrust bearing 5c on the opposite-to-output side “Lb”, and a second housing member 22 in a cup-like shape which holds the radial bearing 5b on the output side “La”.

The stator board 3 is a sheet-like member (circuit board) in which the stator coil 3a is formed by copper foil patterns laminated on a sheet-shaped substrate 3b or a thin plate-shaped substrate 3b and an insulating layer is formed on the surface of the copper foil pattern. As an example for the stator board 3 in a sheet-like shape, an FP coil (fine pattern coil/registered trademark of ASAHI KASEI ELECTRONICS Co., Ltd.) may be used.

The stator board 3 is sandwiched and held by housing members which are adjacent to each other in the motor axial line “Lm” direction in a plurality of housing members used in the motor housing 2. More specifically, the first housing member 21 in the motor housing 2 is provided with a body part 21e in a cylindrical tube shape which is protruded toward the output side “La”. The body part 21e is continuously formed over the entire periphery. Further, the second housing member 22 is provided with a body part 22e in a cylindrical tube shape which is protruded toward the opposite-to-output side “Lb”. The body part 22e is continuously formed over the entire periphery. Therefore, the motor housing 2 covers a space where the rotor 4 and the like are disposed over the entire periphery. Further, end parts 21a and 22a of the body parts 21e and 22e of the first housing member 21 and the second housing member 22 are closely disposed each other in the motor axial line “Lm” direction. Further, the outer peripheral side end part 3e of the stator board 3 is located between the end parts 21a and 22a of the body parts 21e and 22e over the substantially entire periphery and is sandwiched and held by the end parts 21a and 22a of the body parts 21e and 22e over the substantially entire periphery. In this structure, a portion of the stator board 3 which is extended and drawn to an outer side is sandwiched and held by the end parts 21a and 22a of the body parts 21e and 22e.

In accordance with an embodiment of the present invention, the outer peripheral side end part 3e of the stator board 3 may be sandwiched and held when the first housing member 21 and the second housing member 22 are joined to each other, or may be adhesively bonded to the first housing member 21 and the second housing member 22.

Further, as shown in FIG. 1(b), it may be structured that stepped parts 21f and 22f protruding in opposite directions to each other are formed at the end parts 21a and 22a of the body parts 21e and 22e except portions from which the stator board 3 is extended and drawn to the outer side, and the outer peripheral side end part 3e of the stator board 3 is sandwiched and held by the stepped parts 21f and 22f.

As described above, in the motor 1 in this embodiment, the auxiliary yoke 11a is attached to the rotor 4 and the auxiliary yoke 11a is integrally rotated with the rotor 4. Therefore, a magnetic attraction force acted between the magnet 8 and the auxiliary yoke 11a does not act on the rotation shaft 5 as a thrust force. Further, since the magnet 8 and the auxiliary yoke 11a are integrally rotated with each other, an eddy current is not generated in the auxiliary yoke 11a and thus a braking force due to the eddy current is not applied to the rotor 4. Therefore, occurrence of friction between the thrust bearing 5c and the rotation shaft 5 can be reduced and a torque loss due to the eddy current is avoided. Further, a structure in which the thrust bearing 5c is not used may be adopted.

Further, the auxiliary yoke 11a is formed in a simple structure in which, in the auxiliary yoke mounting member 7 provided with the tube part 7a into which the rotation shaft 5 is fitted, the auxiliary yoke 11a is provided in a portion whose diameter is enlarged from the end part of the tube part 7a and which faces the stator board 3 on the opposite-to-output side “Lb” and thus a high degree of positional accuracy of the auxiliary yoke 11a is attained. In other words, the auxiliary yoke 11a is simply structured in the auxiliary yoke mounting member 7 made of a magnetic member so that the auxiliary yoke 11a is formed of a ring-shaped large diameter part 7c which is enlarged from the end part on the output side “La” of the tube part 7a into which the rotation shaft 5 is fitted. Therefore, dimensional errors of the respective portions are not accumulated in the positional accuracy of the auxiliary yoke 11a. Accordingly, since a high degree of positional accuracy of the auxiliary yoke 11a is attained, in a case that the rotor 4 is rotated at a high speed in a state that a magnetic attraction force is acted between the magnet 8 and the auxiliary yoke 11a, even when the auxiliary yoke 11a is deformed to some extent, the auxiliary yoke 11a is prevented from contacting with the stator board 3. Further, since the tube part 7a is provided, when a dimension in the axial direction of the tube part 7a is secured, positional accuracy of the auxiliary yoke 11a, i.e., the large diameter part 7c in a direction perpendicular to the motor axial line “Lm” direction can be easily enhanced.

Further, the motor housing 2 is structured of a plurality of housing members (first housing member 21 and second housing member 22) and the outer peripheral side end part 3e of the stator board 3 is sandwiched and held by the first housing member 21 and the second housing member 22. Therefore, positional accuracy in the motor axial line “Lm” direction of the stator board 3 is high and thus the stator board 3 and the auxiliary yoke 11a are prevented from contacting with each other.

Further, in this embodiment, since the stator board 3 is thin and thus a portion of the stator board 3 which faces the auxiliary yoke 11a in the motor axial line “Lm” direction is easily resulted in low positional accuracy. However, in this embodiment, since positional accuracy of the auxiliary yoke 11a is high, even when the position of a portion of the stator board 3 which faces the auxiliary yoke 11a is displaced to some extent, the stator board 3 is prevented from contacting with the auxiliary yoke 11a.

Further, since the motor housing 2 covers the entire periphery or the substantially entire periphery in the circumferential direction of the rotor 4, the structure can be adopted in which the outer peripheral side end part 3e of the stator board 3 is sandwiched and held by the first housing member 21 and the second housing member 22 over a wide range in the circumferential direction and thus the stator board 3 is held surely. This effect can be attained when the outer peripheral side end part 3e of the stator board 3 is sandwiched and held in the circumferential direction as a whole. Therefore, the outer peripheral side end part 3e is not required to be sandwiched and held by the first housing member 21 and the second housing member 22 over the substantially entire periphery. Further, when the entire periphery or the substantially entire periphery in the circumferential direction of the rotor is covered by the motor housing 2, foreign matters such as dust are prevented from entering into the inside of the motor housing 2.

### Second Embodiment

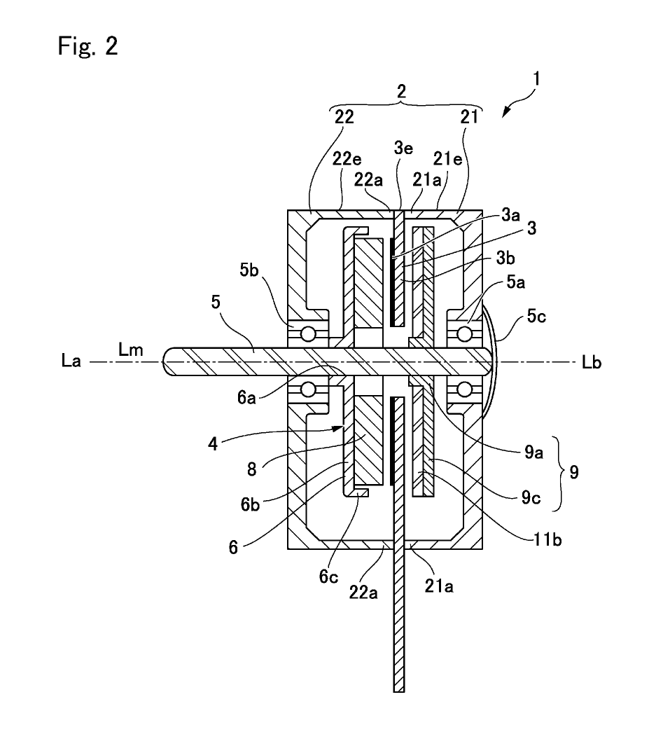

FIG. 2 is an explanatory view schematically showing a cross sectional structure of a motor in accordance with a second embodiment of the present invention. The basic structure in the second embodiment is similar to the first embodiment and thus the same reference signs are used in common portions and their descriptions are omitted.

As shown in FIG. 2, a motor 1 in the second embodiment is, similarly to the first embodiment, a surface facing type motor in which a magnet 8 of a rotor 4 and a stator coil 3a are faced each other in a motor axial line “Lm” direction. The motor 1 includes a motor housing 2, a rotor 4 provided with a rotation shaft 5 which is rotatably held with respect to the motor housing 2 by radial bearings 5a and 5b and a thrust bearing 5c, and a stator board 3 provided with a stator coil 3a which faces the magnet 8 of the rotor 4 on an opposite-to-output side “Lb” in the motor axial line “Lm” direction. The rotor 4 is provided with a back yoke 6 on an output side “La” in the motor axial line “Lm” direction with respect to the magnet 8.

Further, also in the second embodiment, similarly to the first embodiment, the motor 1 is provided with an auxiliary yoke 11b in a ring shape on an opposite side (opposite-to-output side “Lb”) to the side where the magnet 8 is located with respect to the stator coil 3a. In this embodiment, the auxiliary yoke 11b is attached to the rotor 4.

In order to realize the above-mentioned structure, the auxiliary yoke 11b is provided in a portion whose diameter is enlarged from a tube part 9a and which faces the stator board 3 on the opposite-to-output side “Lb” in an auxiliary yoke mounting member 9 provided with the tube part 9a into which the rotation shaft 5 is fitted. More specifically, the auxiliary yoke mounting member 9 is a nonmagnetic member provided with the tube part 9a, to which the rotation shaft 5 is fitted and fixed so as to be integrally rotated with each other, and a large diameter part 9c in a ring shape whose diameter is enlarged from an end part on the opposite-to-output side “Lb” of the tube part 9a. In the auxiliary yoke mounting member 9, the auxiliary yoke 11b made of a ring-shaped magnetic plate is fixed to a face on the output side “La” of the large diameter part 9c with an adhesive or the like. As described above, the auxiliary yoke 11b integrally rotated with the rotor 4 is disposed on an opposite side (opposite-to-output side “Lb”) to the side where the magnet 8 is located with respect to the stator coil 3a. Other structures are similar to the first embodiment and thus their descriptions are omitted.

Also in the motor 1 structured as described above, the auxiliary yoke 11b is formed in a simple structure in which, in the auxiliary yoke mounting member 9 provided with the tube part 9a into which the rotation shaft 5 is fitted, the auxiliary yoke 11b is provided in a portion whose diameter is enlarged from the end part of the tube part 9a and which faces the stator board 3 on the opposite-to-output side “Lb” and thus a high degree of positional accuracy of the auxiliary yoke 11b is attained. In other words, the auxiliary yoke 11b is formed in a simple structure in which the auxiliary yoke 11b is made of a magnetic plate which is fixed to the ring-shaped large diameter part 9c enlarged from the tube part 9a in the nonmagnetic auxiliary yoke mounting member 9. Therefore, dimensional errors of the respective portions are not accumulated in the positional accuracy of the auxiliary yoke 11b. Further, the auxiliary yoke mounting member 9 is fixed to the rotation shaft 5 through the tube part 9a and thus positional accuracy of the large diameter part 9c which is disposed in a direction perpendicular to the motor axial line “Lm” direction can be enhanced through the tube part 9a. Therefore, positional accuracy of the auxiliary yoke 11b which is disposed in a direction perpendicular to the motor axial line “Lm” direction can be enhanced. Accordingly, since a high degree of positional accuracy of the auxiliary yoke 11b is attained, similar effects to the first embodiment can be attained in the second embodiment. In other words, for example, in a case that the rotor 4 is rotated at a high speed in a state that a magnetic attraction force is acted between the magnet 8 and the auxiliary yoke 11b, even when the auxiliary yoke 11b is deformed to some extent, the auxiliary yoke 11b is prevented from contacting with the stator board 3.

### FIRST APPLICATION EXAMPLE TO ROTARY DRIVE DEVICE (ROTARY SHUTTER DEVICE)

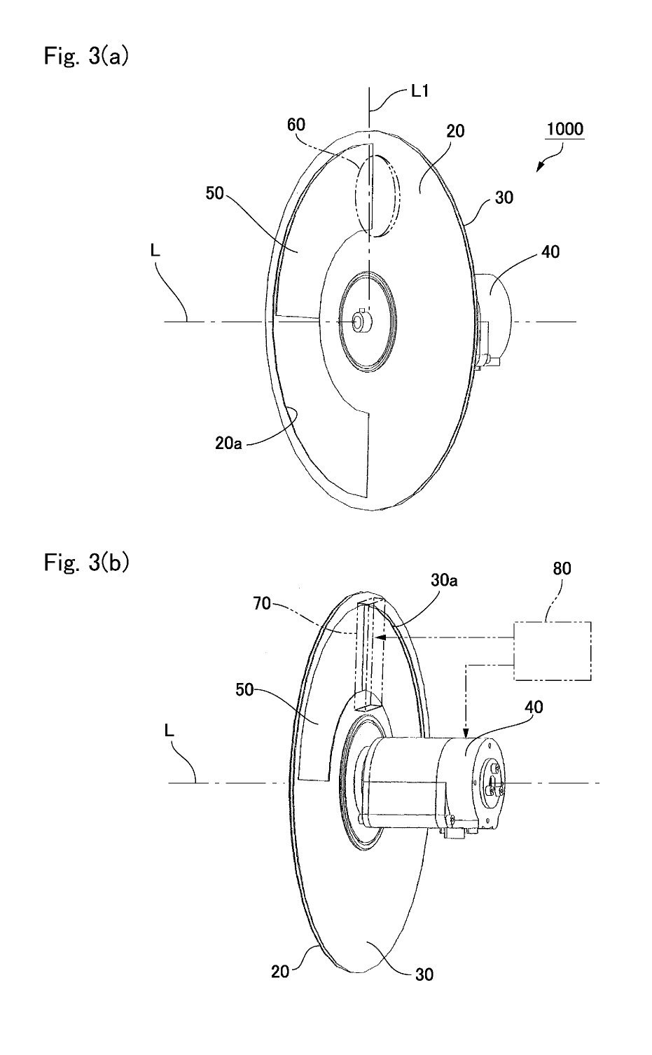

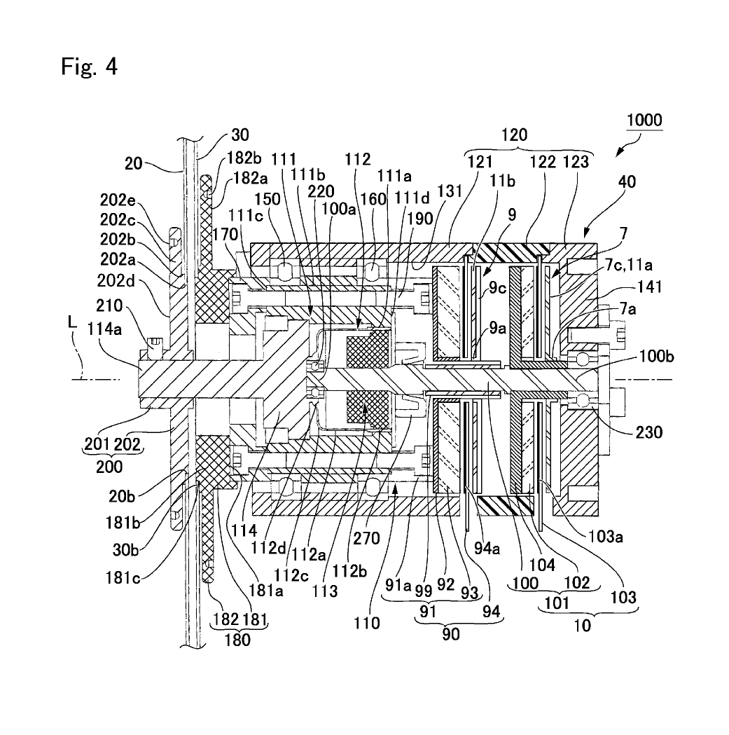

FIGS. 3(a) and 3(b) are explanatory views showing an outward appearance of a rotary shutter device and the like to which at least an embodiment of the present invention is applied. FIG. 3(a) is a perspective view showing the rotary shutter device which is viewed from a front side and FIG. 3(b) is a perspective view showing the rotary shutter device which is viewed from a rear side. FIG. 4 is a longitudinal sectional view showing the rotary shutter device in FIGS. 3(a) and 3(b).

As shown in FIGS. 3(a) and 3(b), a rotary shutter device 1000 is structured so that a first shutter plate 20 (first rotating plate/first driven member), a second shutter plate 30 (second rotating plate / second driven member) and a rotary drive mechanism 40 are coaxially disposed on a rotation center axial line “L” in this order. In the following descriptions, when a side where the first shutter plate 20 is disposed is set to be a front side in the rotation center axial line “L” direction, the rotary drive mechanism 40 is disposed on a rear side with respect to the first shutter plate 20 and the second shutter plate 30. The first shutter plate 20 and the second shutter plate 30 are a circular plate whose diameter is larger than that of the rotary drive mechanism 40. The first shutter plate 20 is provided with a light transmitting part and a light shielding part and a first opening part 20a (first light transmitting part) formed in a fan shape is formed at a predetermined position in a radial direction “L1” of its circular side face over an angular range of 180 degrees. The second shutter plate 30 is also provided with a light transmitting part and a light shielding part and is formed in the same shape as the first shutter plate 20. A second opening part 30a (second light transmitting part) formed in a fan shape is formed in the second shutter plate 30 at a predetermined position in the radial direction “L1” of its circular side face over an angular range of 180 degrees. The first shutter plate 20 and the second shutter plate 30 are faced each other through a narrow clearance and, in FIGS. 3(a) and 3(b), the phases of the first opening part 20a and the second opening part 30a are shifted by 90 degrees. Further, a fan-shaped shutter opening 50 is formed over an angular range of 90 degrees by an overlapped portion of the first opening part 20a and the second opening part 30a. The shutter opening 50 is located on an outer peripheral side with respect to an outer peripheral face of the rotary drive mechanism 40.

When the rotary shutter device 1000 is assembled into a photographing camera, as shown by an imaginary line (two-dot chain line) in the drawing, a photographing lens 60 is disposed on the front side of the first shutter plate 20 and an exposure part 70 such as a CCD is disposed on the rear side of the second shutter plate 30. When the first shutter plate 20 and the second shutter plate 30 are driven and rotated by the rotary drive mechanism 40, the shutter opening 50 passes through between the photographing lens 60 and the exposure part 70. The rotary drive mechanism 40 is, for example, controlled and driven by a drive control section 80 for a photographing camera.

As shown in FIG. 4, the rotary drive mechanism 40 is provided with a first actuator 90, a second actuator 10, a wave motion gear mechanism 110, and a motor housing 120 which covers an entire periphery or a substantially entire periphery in a circumferential direction of these portions. The motor housing 120 is provided with a first housing member 121 in a tube-like shape which is located on a side of the first shutter plate 20 and the second shutter plate 30, a second housing member 122 in a cylindrical tube shape which is connected with a rear side of the first housing member 121, and a third housing member 123 in a bottomed cylindrical tube shape which is connected with a rear side of the second housing member 122. The wave motion gear mechanism 110 and the first actuator 90 are, from the front side, disposed on an inner side of the first housing member 121 and the second housing member 122. Further, the second actuator 10 is disposed on an inner side of the second housing member 122 and the third housing member 123. The wave motion gear mechanism 110 is rotationally supported with respect to the first housing member 121 around the rotation center axial line “L” by two bearings 150 and 160, which are arranged between the wave motion gear mechanism 110 and an inner peripheral face 131 of the first housing member 121 at a separated position in the rotation center axial line “L” direction. Further, the wave motion gear mechanism 110, the first actuator 90 and the second actuator 10 are coaxially disposed on the rotation center axial line “L”.

The wave motion gear mechanism 110 is a harmonic drive (registered trademark) system which is a flexible-meshing type wave motion gear mechanism. The wave motion gear mechanism 110 is provided with a circular spline 111 (first input rotation member) in a tube-like shape having internal teeth 111a, a flex spline 112 (output rotation member) in a cup-like shape which is disposed on an inner side of the circular spline 111 and is provided with outer teeth 112b whose teeth number is two pieces less than the teeth number of the internal teeth 111a on an outer peripheral face of a cylindrical tube portion 112a, and a wave generator 113 (second input rotation member) which makes the flex spline 112 resiliently bend to partially mesh the outer teeth 112b with the internal teeth 111a and to occur a relative turning between the circular spline 111 and the flex spline 112 by moving the meshing position in a circumferential direction. The wave motion gear mechanism 110 is a transmission mechanism in which a rotational speed of the flex spline 112 is determined by rotational speeds of the circular spline 111 and the wave generator 113.

The circular spline 111 is rotationally supported around the rotation center axial line “L” by the bearings 150 and 160 which are disposed between the outer peripheral face 111b of the circular spline 111 and the inner peripheral face 131 of the first housing member 121. A front end face 111c of the circular spline 111 is coaxially attached with a first ring hub 180 having a hollow portion at its center part through a cap 170 so as to rotate integrally with the circular spline 111. The second shutter plate 30 is adhesively fixed to the first ring hub 180 (attaching member) with an adhesive so as to be coaxial with the first ring hub 180. Further, a rear end face 111d of the circular spline 111 is coaxially connected with a rotor 91 of the first actuator 90 by fixing bolts 190. Therefore, when the first actuator 90 is rotationally driven, the circular spline 111 and the second shutter plate 30, which is fixed to the circular spline 111 through the cap 170 and the first ring hub 180, are rotated.

The first ring hub 180 is provided with a tube-like portion 181 and a ring-shaped plate portion 182 which is protruded to an outer peripheral side from the middle in the axial direction of the tube-like portion 181. A rear end face 181a of the tube-like shape portion 181 is fixed to the cap 170. A front end portion 181b of the tube-like portion 181 is formed with a ring-shaped stepped part 181c. The second shutter plate 30 is fixed to the first ring hub 180 with an adhesive in a state that a circular opening 30b formed at a center part of the second shutter plate 30 is fitted to the ring-shaped stepped part 181c. The ring-shaped plate portion 182 faces the second shutter plate 30 which is fixed to the first ring-shaped stepped part 181c at a position with a gap space therebetween. An outer peripheral side portion of a rear end face 182a of the ring-shaped plate portion 182 is formed with a ring-shaped groove 182b (recessed part). Rotation balance of the second shutter plate 30 fixed to the first ring hub 180 can be adjusted by applying an adhesive (adjustment member) to the ring-shaped groove 182b.

An output shaft 114 integrally formed with the flex spline 112 is extended in a coaxial state to the front side from a ring-shaped boss portion 112d formed at a center of a diaphragm portion 112c of the flex spline 112. The output shaft 114 is penetrated through a hollow portion of the first ring hub 180 and its front end portion 114a is protruded to the front side with respect to the second shutter plate 30. A second ring hub 200 (attaching member) is coaxially attached to the front end portion 114a so as to be integrally rotated with the output shaft 114. The first shutter plate 20 is adhesively fixed to the second ring hub 200 with an adhesive.

The second ring hub 200 is provided with a tube-like portion 201 and a ring-shaped plate portion 202 which is protruded to an outer peripheral side from the middle in the axial direction of the tube-like portion 201. A front end part of the tube-like portion 201 is fixed to a front end portion 114a of the output shaft 114 by using a fixing tool 210. The ring-shaped plate portion 202 is formed so as to have a wider wall thickness than the first ring hub 180 and is formed from the rear end side with a first ring-shaped stepped part 202a and a second ring-shaped stepped part 202b having a larger diameter than the first ring-shaped stepped part 202a. The first shutter plate 20 is fixed to the second ring hub 200 with an adhesive in a state that a circular opening 20b formed at a center part of the first shutter plate 20 is fitted to the first ring-shaped stepped part 202a. An outer peripheral side portion 202c of the ring-shaped plate portion 202 with respect to the second ring-shaped stepped part 202b faces the first shutter plate 20 which is fixed to the first ring-shaped stepped part 202a with a gap space therebetween. An outer peripheral side portion of a front end face 202d of the ring-shaped plate portion 202 is formed with a ring-shaped groove 202e. Rotation balance of the first shutter plate 20 fixed to the second ring hub 200 can be adjusted by applying an adhesive (adjustment member) to the ring-shaped groove 202e.

A rotation shaft 100 of the second actuator 10 is coaxially connected with the wave generator 113. Therefore, the wave generator 113 is capable of being rotated by the second actuator 10. A front end portion 100a of the rotation shaft 100 is protruded further forward from the wave generator 113 and is located on an inner side of the ring-shaped boss portion 112d of the flex spline 112. A bearing 220 is disposed between an outer peripheral face of the front end portion 100a of the rotation shaft 100 and an inner peripheral face of the ring-shaped boss portion 112d. The rotation shaft 100 and the flex spline 112 are mutually rotationally supported through the bearing 220 around the rotation center axial line “L”. Therefore, when the second actuator 10 is rotationally driven, the rotation shaft 100 is rotated and thus the wave generator 113, the flex spline 112, and the first shutter plate 20 fixed to the output shaft 114 through the second ring hub 200 are rotated.

The first actuator 90 includes a rotor 91 which is provided from the front side with a ring-shaped plate part 91a, a rotation shaft 99 in a small diameter tube-like shape which is extended to the rear side from a center portion of the ring-shaped plate part 91a, and a ring-shaped magnet 93 which is fixed to the ring-shaped plate part 91a and the rotation shaft 99 through a back yoke 92. Further, a ring-shaped stator board 94 is provided so as to face the magnet 93 of the rotor 91 in the rotation center axial line “L” direction. The stator board 94 is provided with a stator coil 94a. The rotor 91 is connected with the circular spline 111 and thus the rotor 91 is rotationally supported around the rotation center axial line “L” together with the circular spline 111 by the bearings 150 and 160.

The second actuator 10 includes a rotor 101 which is provided from the front side with a rotation shaft 100, a back yoke 104, and a ring-shaped magnet 102 which is fixed to the rotation shaft 100 through the back yoke 104. Further, a stator board 103 is provided so as to face the magnet 102 of the rotor 101 in the rotation center axial line “L” direction. The stator board 103 is provided with a stator coil 103a.

A portion of the rotation shaft 100 which is protruded to the front side with respect to the back yoke 104 of the rotor 101 is extended to the inner side of the wave motion gear mechanism 110. The rotation shaft 100 is rotationally supported by the motor housing 120. In other words, the front end portion 100a of the rotation shaft 100 is supported by the bearing 220, which is disposed on an inner peripheral face of the ring-shaped boss portion 112d, and a rear end portion 100b of the rotation shaft 100 is supported by a bearing 230 which is fixed to a circular end plate 141 of the third housing member 123. An oil-seal 270 of the wave motion gear mechanism 110 is disposed between the first actuator 90 and the wave motion gear mechanism 110 so as to surround the rotation shaft 100.

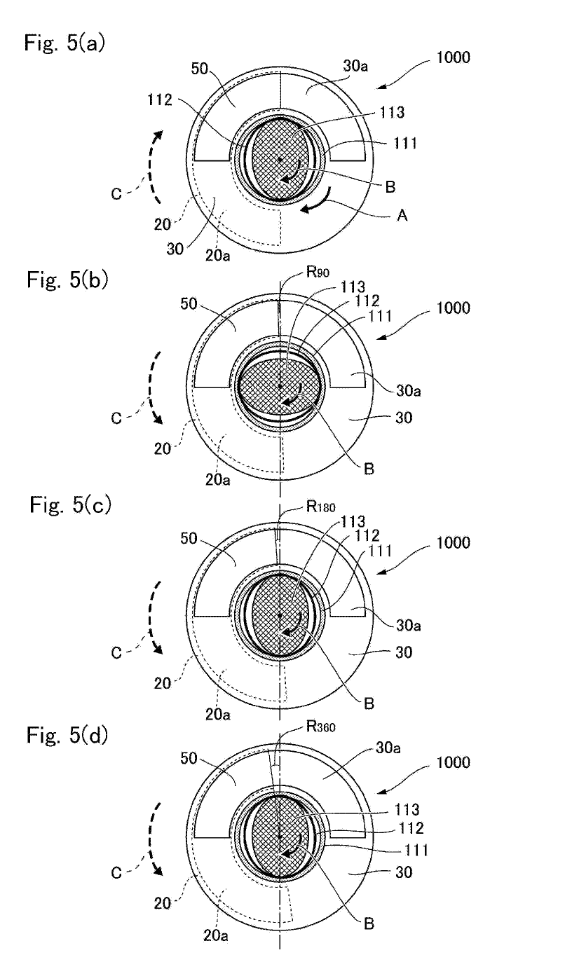

FIGS. 5(a) through 5(d) are explanatory views showing operations of the rotary shutter device in FIGS. 3(a) and 3(b). FIG. 5(a) is an explanatory view showing a state where two shutter plates are rotated at the same speed. FIG. 5(b) is an explanatory view showing a state where the wave generator is relatively turned by 90 degrees with respect to the circular spline. FIG. 5(c) is an explanatory view showing a state where the wave generator is relatively turned by 180 degrees with respect to the circular spline. FIG. 5(d) is an explanatory view showing a state where the wave generator is relatively turned by 360 degrees with respect to the circular spline. In FIGS. 5(a) through 5(d), the arrow “A” indicates turning of the circular spline 111, the arrow “B” indicates turning of the wave generator 113, and the arrow “C” shown by a dotted line indicates turning of the flex spline 112.

In the rotary shutter device 1000 in this example, an opening angle of the shutter opening 50 is, for example, set to 90 degrees in an initial state. In a case that the rotary shutter device 1000 is to be operated, as shown in FIG. 5(a), the drive control section 80 integrally rotates the first shutter plate 20 and the second shutter plate 30 in a clockwise direction at a predetermined rotational speed.

In other words, the drive control section 80 rotationally drives the first actuator 90 and the second actuator 10 in a clockwise direction at the same rotational speed to rotate the circular spline 111 and the wave generator 113 at the same rotational speed. Therefore, the entire wave motion gear mechanism 110 comprised of the circular spline 111, the flex spline 112 and the wave generator 113 are integrally rotated with each other and thus the first shutter plate 20 and the second shutter plate 30 are integrally rotated with each other at the same rotational speed. In the rotary shutter device 1000 in this example, when a shutter speed is set at a high speed, the first shutter plate 20 and the second shutter plate 30 are rotated at a rotational speed of 5000-10000 rotations/second. When the shutter speed is set at a low speed, the first shutter plate 20 and the second shutter plate 30 are rotated at a rotational speed of 200-500 rotations/second.

Next, in a case that an exposure time is to be changed, the drive control section 80 changes a phase between the first opening part 20a of the first shutter plate 20 and the second opening part 30a of the second shutter plate 30 to change an opening angle of the shutter opening 50.

More specifically, the drive control section 80 rotationally drives the first actuator 90 and the second actuator 10 at different rotational speeds from each other. In this example, in order to narrow the shutter opening 50, the rotational speed of the first actuator 90 is relatively delayed with respect to the second actuator 10 so that the wave generator 113 connected with the second actuator 10 is relatively turned in the clockwise direction with respect to the circular spline 111 which is connected with the first actuator 90.

As shown in FIG. 5(b), when the wave generator 113 is relatively turned by 90 degrees in the clockwise direction with respect to the circular spline 111, the flex spline 112 is elastically deformed to move a meshing position with the internal teeth 111a of the circular spline 111 in the clockwise direction. When the wave generator 113 is relatively turned by 90 degrees, the flex spline 112 is moved in the counter-clockwise direction with respect to the circular spline 111 by an angle “R90” which corresponds to a half of one tooth of the circular spline 111.

As shown in FIG. 5(c), when the wave generator 113 is relatively turned by 180 degrees with respect to the circular spline 111, the flex spline 112 is moved in the counter-clockwise direction with respect to the circular spline 111 by an angle “R180” which corresponds to one tooth of the circular spline 111.

In addition, as shown in FIG. 5(d), when the wave generator 113 is relatively turned by 360 degrees with respect to the circular spline 111, since the teeth number of the flex spline 112 is two less than that of the circular spline 111, the flex spline 112 is moved in the counter-clockwise direction with respect to the circular spline 111 by an angle “R360” which corresponds to two teeth of the circular spline 111. As a result, the opened angle of the shutter opening 50 is reduced and thus the shutter opening 50 is narrowed.

In other words, when the teeth number of the internal teeth 111a of the circular spline 111 is set to be “m”, a difference of the teeth numbers of the circular spline 111 and the flex spline 112 is set to be “n” (n=2), and a relative turning angle of the wave generator 113 with respect to the circular spline 111 is set to be “0”, a phase difference “Rθ” obtained by the following expression (1) is occurred between the flex spline 112 and the circular spline 111.

Rθ=n·θ/m (1)

Further, the phase difference “Rθ” is reflected in the phase of the first opening part 20a and the second opening part 30a. Therefore, the drive control section 80 controls the relative turning angle “θ” of the wave generator 113 with respect to the circular spline 111 on the basis of a relative turning speed and a relative turning period of the first actuator 90 and the second actuator 10 and thus the opening angle of the shutter opening 50 can be set with a high degree of accuracy.

After the opening angle of the shutter opening 50 is set at a desired angle, the drive control section 80 rotates the first shutter plate 20 and the second shutter plate 30 integrally at a predetermined rotational speed again. In other words, as shown in FIG. 5(a), the first actuator 90 and the second actuator 10 are rotationally driven at the same rotational speed to rotate the entire wave motion gear mechanism 110 integrally.

An operation for setting the opening angle of the shutter opening 50 to a desired angle is continuously performed from an operation for rotationally driving the first actuator 90 and the second actuator 10 at the same rotational speed. Further, an operation for rotationally driving the first actuator 90 and the second actuator 10 at the same rotational speed after the opening angle of the shutter opening 50 has been set to a desired angle is also continuously performed.

As described above, in the rotary shutter device 1000 in this example, the first shutter plate 20 and the second shutter plate 30 are integrally rotated at the same speed by utilizing the only wave motion gear mechanism 110 and, in addition, the phase between the first opening part 20a and the second opening part 30a is varied by relatively turning the first shutter plate 20 and the second shutter plate 30. Further, the number of the rotation members arranged on the drive-force transmission path reaching from the first actuator 90 and the second actuator 10 to the first shutter plate 20 and the second shutter plate 30 is three, i.e., a small number and thus the first shutter plate 20 and the second shutter plate 30 can be suitably rotated at a high speed. Further, in a case that the number of the rotation members disposed on the drive force transmission path is small, errors occurred on the drive force transmission path are reduced when the phase between the first shutter plate 20 and the second shutter plate 30 is varied. As a result, according to the rotary shutter device 1000 in this example, the opening angle of the shutter opening 50 can be controlled with a high degree of accuracy on the basis of the expression (1) which is determined by the transmission ratio of the wave motion gear mechanism 110.

In accordance with an embodiment of the present invention, it may be structured that the first actuator 90 and the second actuator 10 are connected with the flex spline 112 and the wave generator 113 and the first shutter plate 20 is attached to the flex spline 112 or the wave generator 113 and the second shutter plate 30 is attached to the circular spline 111 and, also in this case, the similar operations and effects as described above can be obtained. Further, instead of the wave motion gear mechanism 110, a planet gear mechanism may be used which is provided with three rotation members comprised of an internal gear, a sun gear, and a planetary carrier provided with a planetary gear meshed with the internal gear and the sun gear. In this case, for example, a rotary shutter device may be structured in which the internal gear corresponds to the circular spline 111, the sun gear corresponds to the wave generator 113, and the planetary carrier corresponds to the flex spline 112. When the planetary gear mechanism is to be used, either two of the three rotation members, i.e., two of the internal gear, the sun gear and the planetary carrier are connected with the first motor and the second motor, and the remaining one rotation member and the rotation member with which the first motor or the second motor is connected are attached to a first shutter plate and a second shutter plate and, also in this case, the similar operations and effects as described above can be obtained.

In the rotary shutter device 1000 in this example, two actuators (first actuator 90 and second actuator 10) are used as a rotation drive source for the first shutter plate 20 and the second shutter plate 30. The structure of the motor 1 (see FIG. 1(a)) in accordance with the first embodiment is adopted in the second actuator 10 and the structure of the motor 1 (see FIG. 2) in accordance with the second embodiment is adopted in the first actuator 90.

More specifically, in the first actuator 90, an outer peripheral side end part of a stator board 94 is sandwiched and held by the first housing member 121 and the second housing member 122 and, in the second actuator 10, an outer peripheral side end part of a stator board 103 is sandwiched and held by the second housing member 122 and the third housing member 123.

Further, in the first actuator 90, the auxiliary yoke 11b in the rotor 91 is provided in a portion whose diameter is enlarged from a tube part 9a and which faces the stator board 94 on the rear side in an auxiliary yoke mounting member 9 provided with the tube part 9a to which the rotation shaft 99 is fitted. More specifically, the auxiliary yoke mounting member 9 is a nonmagnetic member which is provided with the tube part 9a, to which the rotation shaft 99 is fitted and fixed, and a ring-shaped large diameter part 9c which is enlarged from an end part on the rear side of the tube part 9a. In the auxiliary yoke mounting member 9, the auxiliary yoke 11b made of a ring-shaped magnetic plate is fixed on a front side face of the large diameter part 9c with an adhesive or the like.

Further, in the second actuator 10, the auxiliary yoke 11a provided in the rotor 101 is, in the auxiliary yoke mounting member 7 provided with a tube part 7a to which the rotation shaft 100 is fitted and fixed, provided in a portion whose diameter is enlarged from the tube part 7a and which faces the stator board 103 on the rear side. More specifically, the auxiliary yoke mounting member 7 is a magnetic member which is provided with the tube part 7a to which the rotation shaft 100 is fitted and a ring-shaped large diameter part 7c which is enlarged from an end part on the front side of the tube part 7a. The auxiliary yoke 11a is structured of the large diameter part 7c.

Therefore, the first actuator 90 and the second actuator 10 are provided with the similar effects described in the first embodiment and the second embodiment.

### SECOND APPLICATION EXAMPLE TO ROTARY DRIVE DEVICE (ROTARY SHUTTER DEVICE)

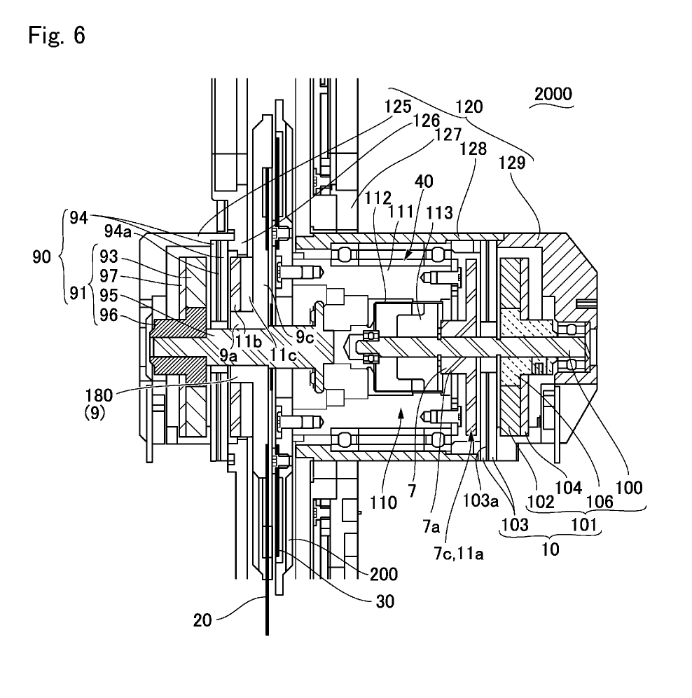

FIG. 6 is a longitudinal sectional view showing another rotary shutter device to which at least an embodiment the present invention is applied. The basic structure in this example is similar to the embodiments described with reference to FIGS. 3(a) through 5(d) and thus the same reference signs are used in common portions and their descriptions are omitted.

As shown in FIG. 6, in a rotary shutter device 2000 in this example, the rotary drive mechanism 40 is provided with a first actuator 90, a second actuator 10, a wave motion gear mechanism 110, and a motor housing 120 which covers an entire periphery or a substantially entire periphery in a circumferential direction of these portions. The motor housing 120 is formed of a plurality of housing members 125 through 129. The first actuator 90 is disposed on an inner side of the housing member 125 and the wave motion gear mechanism 110 and the second actuator 10 are disposed on an inner side of the housing members 128 and 129. Further, the wave motion gear mechanism 110, the first actuator 90 and the second actuator 10 are coaxially disposed on a rotation center axial line.

In the rotary shutter device 2000, the first actuator 90 is provided with a rotor 91 in which a magnet 93 is fixed to a rotation shaft 95 through a connecting member 96 in a cylindrical tube shape. In the rotor 91, a back yoke 97 is provided on a rear side of the magnet 93 (front side). Further, two stator boards 94 provided with a stator coil 94a are disposed in a superposed manner at a facing position to the magnet 93 on the rear side. In the stator board 94, the stator coil 94a is covered with an insulation film (not shown) and thus, even when the stator board 94 is disposed so as to be superposed on the stator coil 94a, a short circuit is not occurred. In this example, a first ring hub 180 is fixed to the rotation shaft 95 and a first shutter plate 20 is connected with the first ring hub 180.

Further, in the rotary shutter device 2000, the second actuator 10 is provided with a rotor 101 in which a magnet 102 is fixed to a rotation shaft 100 through a connecting member 106 formed in a cylindrical tube shape. In the rotor 101, a back yoke 104 is provided on a back side of the magnet 102 (rear side). Further, two stator boards 103 provided with a stator coil 103a are disposed in a superposed manner at a facing position to the magnet 102 on the front side. In the stator board 103, the stator coil 103a is covered with an insulation film (not shown) and thus, even when the stator board 103 is disposed so as to be superposed on the stator coil 94a, a short circuit is not occurred.

The wave motion gear mechanism 110 is a harmonic drive system (registered trademark) which is a flexible-meshing type wave motion gear mechanism. The wave motion gear mechanism 110 is provided with a circular spline 111 (first input rotation member) formed in a tube-like shape, a flex spline 112 (output rotation member) which is formed in a cup-like shape and is disposed on an inner side of the circular spline 111, and a wave generator 113 (second input rotation member) which makes the flex spline 112 resiliently bend to move the meshing position in a circumferential direction.

The wave generator 113 is connected with the rotation shaft 100 of the second actuator 10 and the circular spline 111 is connected with a second ring hub 200 with which the second shutter plate 30 is connected. Therefore, the first shutter plate 20 is directly driven by the first actuator 90 and the second shutter plate 30 is driven by the second actuator 10 through the wave motion gear mechanism 110. Accordingly, the first shutter plate 20 and the second shutter plate 30 are capable of performing similar operations to the operations described with reference to FIG. 4 and FIG. 5(a) through 5(d).

In the rotary shutter device 2000 structured as described above, two actuators (first actuator 90 and second actuator 10) are used as a rotation drive source for the first shutter plate 20 and the second shutter plate 30. The structure of the motor 1 (see FIG. 1(a)) in accordance with the first embodiment 1 is adopted in the second actuator 10 and the structure of the motor 1 (see FIG. 2) in accordance with the second embodiment is adopted in the first actuator 90.

More specifically, in the first actuator 90, the outer peripheral side end parts of the stator boards 94 are sandwiched and held by the housing members 125 and 126 adjacent to each other in the rotation center axial line direction and, in the second actuator 10, the outer peripheral side end parts of the stator boards 103 are sandwiched and held by the housing members 128 and 129 adjacent to each other in the rotation center axial line direction.

Further, in the first actuator 90, the auxiliary yoke 11b in the rotor 91 is provided by utilizing the first ring hub 180 as the auxiliary yoke mounting member 9. In other words, the first ring hub 180 (auxiliary yoke mounting member 9) is formed with a portion whose diameter is enlarged from a tube part 9a to which the rotation shaft 99 is fitted and which faces the stator board 94 on the rear side, and the auxiliary yoke 11b is provided in the portion enlarged from the tube part 9a. More specifically, the auxiliary yoke mounting member 9 (first ring hub 180) is a nonmagnetic member which is provided with the tube part 9a, to which the rotation shaft 95 is fitted and fixed, and a ring-shaped large diameter part 9c which is enlarged from an end part on the rear side of the tube part 9a. In the auxiliary yoke mounting member 9, the auxiliary yoke 11b made of a ring-shaped magnetic plate is fixed on a front side face of the large diameter part 9c through a spacer 11c with an adhesive or the like.

Further, in the second actuator 10, the auxiliary yoke 11a in the rotor 101 is, in the auxiliary yoke mounting member 7 provided with a tube part 7a to which the rotation shaft 100 is fitted and fixed, provided in a portion whose diameter is enlarged from the tube part 7a and which faces the stator board 103 on the front side. More specifically, the auxiliary yoke mounting member 7 is a magnetic member which is provided with the tube part 7a to which the rotation shaft 100 is fitted and a ring-shaped large diameter part 7c which is enlarged from an end part on the rear side of the tube part 7a. The auxiliary yoke 11a is structured of the large diameter part 7c.

Therefore, the first actuator 90 and the second actuator 10 are provided with the similar effects described in the first embodiment and the second embodiment.

While the description above refers to particular embodiments of the present invention, it will be understood that many modifications may be made without departing from the spirit thereof. The accompanying claims are intended to cover such modifications as would fall within the true scope and spirit of the present invention.

The presently disclosed embodiments are therefore to be considered in all respects as illustrative and not restrictive, the scope of the invention being indicated by the appended claims, rather than the foregoing description, and all changes which come within the meaning and range of equivalency of the claims are therefore intended to be embraced therein.

What is claimed is:

1. A motor comprising:
a motor housing;
a rotor which is provided with a rotation shaft rotatably held with respect to the motor housing, a magnet held by the rotation shaft, and a back yoke facing the magnet on one side in a motor axial line direction;
a stator board which is provided with a stator coil facing the magnet on an other side in the motor axial line direction;
an auxiliary yoke mounting member which is provided with a tube part to which the rotation shaft is fitted and fixed; and
an auxiliary yoke which is provided in a portion of the auxiliary yoke mounting member whose diameter is enlarged from the tube part and which faces the stator board on the other side in the motor axial line direction.

2. The motor according to claim 1, wherein
the auxiliary yoke mounting member is a magnetic member which is provided with a large diameter portion which is enlarged from the tube part and which faces the stator board on the other side in the motor axial line direction, and
the auxiliary yoke is structured of the large diameter portion.

3. The motor according to claim 2, wherein
the motor housing comprises a plurality of housing members, and
an outer peripheral side end part of the stator board is sandwiched and held by the housing members adjacent to each other in the motor axial line direction.

4. The motor according to claim 3, wherein the stator board is provided with the stator coil which is formed with a copper foil pattern laminated on a substrate in a sheet-like shape or a thin plate shape.

5. The motor according to claim 3, wherein the motor housing covers the rotor over an entire periphery or a substantially entire periphery in a circumferential direction of the rotor.

6. The motor according to claim 1, wherein
the auxiliary yoke mounting member is provided with a large diameter portion whose diameter is enlarged from the tube part and which faces the stator board on the other side in the motor axial line direction, and
the auxiliary yoke is fixed to the large diameter portion.

7. The motor according to claim 6, wherein
the motor housing comprises a plurality of housing members, and
an outer peripheral side end part of the stator board is sandwiched and held by the housing members adjacent to each other in the motor axial line direction.

8. The motor according to claim 7, wherein the stator board is provided with the stator coil which is formed with a copper foil pattern laminated on a substrate in a sheet-like shape or a thin plate shape.

9. The motor according to claim 7, wherein the motor housing covers the rotor over an entire periphery or a substantially entire periphery in a circumferential direction of the rotor.

10. A rotary drive device comprising:
a first driven member;
a second driven member;
a first actuator which is a rotation drive source for the first driven member; and
a second actuator which is a rotation drive source for the second driven member;
wherein at least one of the first actuator and the second actuator is a motor;
wherein the motor comprises:
a motor housing;
a rotor which is provided with a rotation shaft rotatably held with respect to the motor housing, a magnet held by the rotation shaft, and a back yoke facing the magnet on one side in a motor axial line direction;
a stator board which is provided with a stator coil facing the magnet on an other side in the motor axial line direction;
an auxiliary yoke mounting member which is provided with a tube part to which the rotation shaft is fitted and fixed; and
an auxiliary yoke which is provided in a portion of the auxiliary yoke mounting member whose diameter is enlarged from the tube part and which faces the stator board on the other side in the motor axial line direction.

11. The rotary drive device according to claim 10, wherein
the first actuator is a first motor which is the motor,
the auxiliary yoke mounting member in the first motor is a magnetic member which is provided with a large diameter portion which is enlarged from the tube part and which faces the stator board on the other side in the motor axial line direction, and
the auxiliary yoke is structured of the large diameter portion.

12. The rotary drive device according to claim 11, wherein
the motor housing in the first motor comprises a plurality of housing members, and
an outer peripheral side end part of the stator board is sandwiched and held by the housing members adjacent to each other in the motor axial line direction.

13. The rotary drive device according to claim 11, wherein
the second actuator is a second motor which is the motor,
the second motor is coaxially disposed with the first motor,
the auxiliary yoke mounting member in the second motor is provided with a large diameter portion which is enlarged from the tube part and which faces the stator board on the other side in the motor axial line direction, and
the auxiliary yoke is fixed to the large diameter portion.

14. The rotary drive device according to claim 13, further comprising a wave motion gear mechanism for transmitting rotations of the first motor and the second motor to the first driven member and the second driven member,
wherein the wave motion gear mechanism comprises:
a circular spline in a tube-like shape having internal teeth,
a flex spline provided with outer teeth whose teeth number is smaller than a teeth number of the internal teeth, and
a wave generator which makes the flex spline resiliently bend to partially mesh the outer teeth with the internal teeth and to occur a relative turning between the circular spline and the flex spline by moving a meshing position of the outer teeth with the internal teeth in a circumferential direction.

15. The rotary drive device according to claim 10, wherein
the second actuator is a second motor which is the motor,
the auxiliary yoke mounting member in the second motor is provided with a large diameter portion which is enlarged from the tube part and which faces the stator board on the other side in the motor axial line direction, and
the auxiliary yoke is fixed to the large diameter portion.

16. The rotary drive device according to claim 15, wherein
the motor housing in the second motor comprises a plurality of housing members, and
an outer peripheral side end part of the stator board is sandwiched and held by the housing members adjacent to each other in the motor axial line direction.

17. The rotary drive device according to claim 10, wherein
the first driven member is a first shutter plate which is provided with a first light transmitting part and a first light shielding part in a circumferential direction,
the second driven member is a second shutter plate which is provided with a second light transmitting part and a second light shielding part in a circumferential direction, and
the first light transmitting part and the second light transmitting part are formed at positions so as to superpose on each other in a rotation center axial line direction.
